(19) United States
(12) Patent Application Publication
(10) Pub. No.: US 2019/0250635 A1
(43) Pub. Date: Aug. 15, 2019

(54) MOBILE SHOP VEHICLE AND MOBILE SHOP SYSTEM

(71) Applicant: Toyota Jidosha Kabushiki Kaisha, Toyota-shi (JP)

(72) Inventors: Michio Ikeda, Nagoya-shi (JP); Eiichi Ishii, Nisshin-shi (JP); Mitsugu Makita, Nagoya-shi (JP); Toru Yoshida, Miyoshi-shi (JP); Gaku Itou, Nagoya-shi (JP)

(21) Appl. No.: 16/275,845

(22) Filed: Feb. 14, 2019

(30) Foreign Application Priority Data
Feb. 15, 2018 (JP) 2018-024963

(51) Int. Cl. G05D 1/02; B60P 3/025

(52) U.S. Cl. CPC G05D 1/0287; G05D 1/0276; G05D 1/0223; B60P 3/025

(57) ABSTRACT

A mobile shop vehicle capable of opening a shop at a destination includes a movement control unit configured to cause the mobile shop vehicle to move autonomously along a predetermined path in a predetermined area while opening a shop and a vehicle distance control unit configured to control the distance to another mobile shop vehicle that is autonomously moving.

### CROSS REFERENCE TO THE RELATED APPLICATION

This application claims priority to Japanese Patent Application No. 2018-024963, filed on Feb. 15, 2018, incorporated herein by reference in its entirety.

### BACKGROUND

### Technical Field

The present disclosure relates to control of a mobile shop.

### Description of the Related Art

Vehicles used as shops or showrooms have been developed (see, for example, Patent Literature 1 in the following citation list). It is possible to gather such mobile shop vehicles in an open space to construct a shopping mall.

Such a shopping mall has the advantage that the layout of the shops can be changed flexibly thanks to the mobility of the mobile shop vehicles.

### CITATION LIST

### Patent Literature

Patent Literature 1: Japanese Patent Application Laid-Open No. 2010-143558

### SUMMARY

Shopping malls composed of mobile shop vehicles have the problem that the customers' effort of visiting shops increases with increasing size of the shopping malls. The layout of shops in shopping malls composed of mobile shop vehicles can change unlike in shopping malls with fixed shops. Therefore, in order to figure out what shops there are in a shopping mall, it is necessary for customers to walk around in the mall by themselves.

The present disclosure has been made in view of the above problem. An object of the present disclosure is to provide an environment that helps customers to visit mobile shop vehicles in a shopping mall composed of a plurality of mobile shop vehicles.

A mobile shop vehicle according to the present disclosure is capable of opening a shop at a destination and comprises a movement controller configured to cause the mobile shop vehicle to move autonomously along a predetermined path in a predetermined area while opening a shop and a vehicle distance controller configured to control the distance to another mobile shop vehicle that is autonomously moving.

The mobile shop vehicle is a vehicle capable of opening a shop to enable sales operations at a destination. In this specification, the expression “opening a shop” means making a shop facility or shop equipment provided in the vehicle operable. The shop may be any kind of shop that sells or offers merchandise or service.

The aforementioned predetermined area is an area in which the shop is opened, which typically is, but not limited to, a park, the site of a public facility, or the site of an apartment complex.

The movement controller of the mobile shop vehicle is configured to cause the mobile shop vehicle to move autonomously at low speed or slow speed along a predetermined path with the shop opened. In some embodiments, the aforementioned predetermined path is a closed path along which the mobile shop vehicle can circulate. The vehicle distance controller is configured to control the distance (vehicle-to-vehicle distance) to another mobile shop vehicle that moves autonomously along that path. With the above-described configuration, it is possible to form a shopping mall by a plurality of mobile shop vehicles, and the shop layout (or the disposition of the shops) can be varied with time by gradual change in the positions of the plurality of mobile shop vehicles that form the shopping mall. Particularly, if a visitor does not move, different shops pass in front of him or her with the lapse of time, providing continuously refreshed experience to the visitor.

The mobile shop vehicle according to the present disclosure may further comprise a second movement controller configured to cause the mobile shop vehicle to move autonomously outside the predetermined area, and the second movement controller may be configured to cause the mobile shop vehicle to move autonomously at a speed higher than the speed of movement in the predetermined area.

As above, in addition to autonomous movement in the aforementioned predetermined area, the mobile shop vehicle may be provided with a unit that causes the mobile shop vehicle to move autonomously in an area outside the predetermined area, in other words in an area in which the shopping mall is not formed, which is typically an area on a road. This enables the mobile shop vehicles to gather by autonomous driving to form a shopping mall.

The movement controller may cause the mobile shop vehicle to move autonomously at a first speed and cause the mobile shop vehicle to move autonomously at a second speed lower than the first speed during a period in which a visitor is getting on or off the mobile shop vehicle.

The period in which a visitor is getting on or off the mobile shop vehicle may be any period including the period through which a visitor to the mobile shop vehicle gets on or off the vehicle. For example, reducing the speed of autonomous movement of the vehicle temporarily when a visitor passes through the entrance improves the safety of operations of the mobile shop vehicle. The second speed may include zero (meaning a stopped state).

A mobile shop system according to the present disclosure includes a plurality of mobile shop vehicles capable of moving autonomously on the basis of an operation command and opening a shop at a destination and a server apparatus that creates the operation command. Each of the mobile shop vehicles comprises a movement controller configured to cause the mobile shop vehicle to move autonomously in a predetermined area while opening a shop on the basis of the operation command. The server apparatus comprises a commander configured to create the operation command so as to cause the plurality of mobile shop vehicles to move along the same path while keeping predetermined intervals between them.

As above, according to the present disclosure, there is also provided a system including a server apparatus that creates operation commands for mobile shop vehicles.

Each of the mobile shop vehicles in this system may further comprise a positional information sender that acquires and sends positional information, and the server apparatus in this system may further comprise a positional information receiver configured to receive the positional information of the plurality of mobile shop vehicles and a map creator configured to create map information representing the disposition of the plurality of mobile shop vehicles.

The mobile shop vehicles may send positional information to the server apparatus, and the server apparatus may create a map representing the disposition of the mobile shop vehicles on the basis of the positional information. Thus, appropriate information about the disposition of the mobile shop vehicles can be provided to visitors.

The map creator may predict the disposition of the mobile shop vehicles at a future time and creates the map information for that time.

The disposition of the mobile shop vehicles can be predicted, for example, on the basis of positional information collected previously, information sent from the mobile shop vehicles, and the operation command sent to the mobile shop vehicles. The time for which map information is to be created may be determined by the server apparatus or by a request from outside (e.g. a request by a visitor).

The created map information may be provided to visitors. For example, the map information may be sent to a terminal that a visitor has. In the case where a mobile shop vehicle is provided with an output unit (e.g. a display device), the map information may be sent to that mobile shop vehicle.

Notice may be given to a user on the basis of the created map information. For example, notice may be given when a designated shop comes to a designated location.

The commander may create an operation command that causes one or some of the plurality of mobile shop vehicles to leave the path or an operation command that causes an additional mobile shop vehicle to enter the path.

The configuration of the shopping mall can be changed flexibly by removing one or some of the plurality of mobile shop vehicles under operation or adding one or more mobile shop vehicles.

According to another aspect of the present disclosure, there is provided a mobile shop vehicle or a mobile shop system including at least one of the units described in the foregoing. According to still other aspects of the present disclosure, there are provided a control method for executing the above-described processes, a program that causes a computer to carry out the control method, and a computer-readable medium in which such a program is stored in a non-transitory manner. The processes and units described above may be employed in any combinations, as far as it is technically feasible to do so.

The present disclosure can provide an environment that helps customers to visit mobile shop vehicles in a shopping mall composed of a plurality of mobile shop vehicles.

### BRIEF DESCRIPTION OF THE DRAWINGS

FIG. 1 is a diagram illustrating the general configuration of a mobile shop system according to a first embodiment.

FIG. 2 is a functional block diagram of the mobile shop system according to the first embodiment.

FIG. 3 is a diagram illustrating a process of operation of the mobile shop system according to the first embodiment.

FIG. 4 is a diagram illustrating a layout of a shopping mall according to the first embodiment.

FIG. 5 is a flow chart of a process executed by a mobile shop vehicle.

FIG. 6 is a functional block diagram of a mobile shop system according to a second embodiment.

FIG. 7 is a diagram illustrating a process of operation of the mobile shop system according to the second embodiment.

FIG. 8 is a functional block diagram of a mobile shop system according to a fourth embodiment.

FIG. 9 is a diagram illustrating a layout of a shopping mall according to a fifth embodiment.

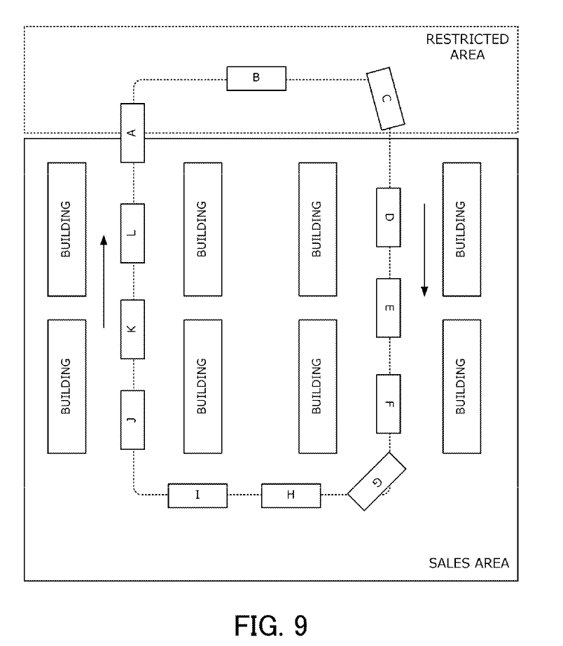

FIG. 10 is a diagram illustrating another layout of a shopping mall according to the fifth embodiment.

### DETAILED DESCRIPTION

### First Embodiment

### Outline of the System

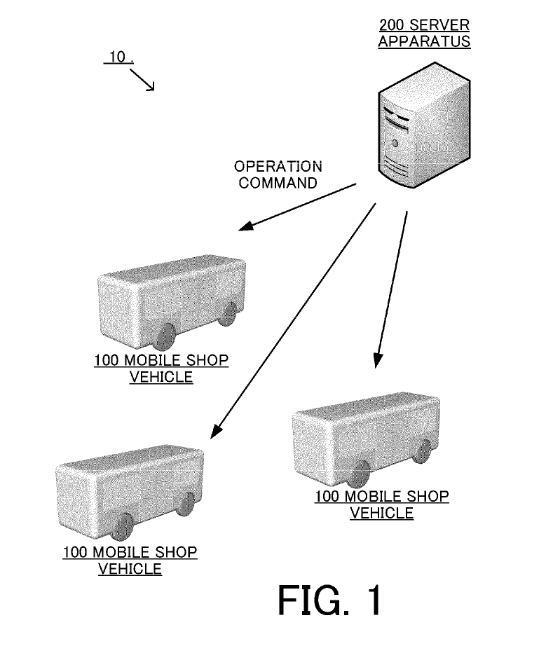

A mobile shop system according to a first embodiment is a system that constructs a shopping mall (or retail complex) by gathering a plurality of mobile shop vehicles. In the following, the mobile shop system 10 according to the first embodiment will be described with reference to FIG. 1. The mobile shop system 10 according to the first embodiment includes a plurality of mobile shop vehicles 100 and a server apparatus 200.

The mobile shop vehicles 100 are multipurpose mobile objects, which may have individually different functions. The mobile shop vehicles 100 according to the first embodiment are capable of moving on roads. The mobile shop vehicle 100 has a facility or equipment for opening a shop inside it and can open a shop using the facility or equipment after travelling to a destination. In this specification, the term “shop” refers to a facility where merchandise (goods) or service is sold or offered with or without charge.

In the illustrative case according to the first embodiment described in the following, it is assumed that a plurality of mobile shop vehicles 100 are gathered in a certain area (or open space) to form a shopping mall. Formed by gathering mobile shop vehicles 100, according to the first embodiment, such a shopping mall can be constructed easily in a place or area where no shops exist. Such a shopping mall may be constructed on a road or private land or in a park or the like. The shops in such a shopping mall may include shops other than the mobile shop vehicles (namely, fixed shops or mobile shops not based on vehicles).

Shopping malls composed of mobile shop vehicles 100 allow the disposition or layout of the mobile shop vehicles 100 to be changed easily. Thus, the positions of the mobile shop vehicles 100 in a shopping mall can be changed, or the mobile shop vehicles 100 in a shopping mall can be varied every day or among different time periods. Changing the positions of shops or replacing shops in a shopping mall may provide a wider variety of shops to visitors (or customers) and increasing sales.

However, in cases where the number of mobile shop vehicles 100 in a shopping mole is large, customers may encounter some problems. Specifically, it may be difficult for customers to figure out how the mobile shop vehicles are arranged or to find a route to be taken to visit a plurality of mobile shop vehicles. Moreover, it may be troublesome for the customers to move between shops.

To solve such problems, the mobile shop system 10 according to this embodiment is configured to cause the mobile shop vehicles disposed in a shopping mall to move at low speed (or slow speed) to change their disposition with time.

Specifically, the server apparatus 200, which manages the mobile shop vehicles, sends operation commands including information about construction of a shopping mall to a plurality of mobile shop vehicles 100, and then the plurality of mobile shop vehicles 100 form the shopping mall on the basis of the operation commands they have received and move at low speed while operating as respective shops. This enables customers to easily access shops that vary with time.

### System Configuration

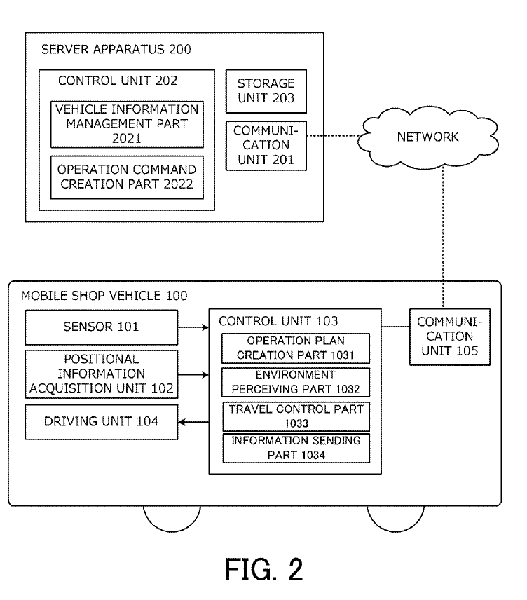

Elements of the system will be described specifically. FIG. 2 is a block diagram illustrating an exemplary configuration of the mobile shop vehicle 100 and the server apparatus 200 in FIG. 1.

### Mobile Shop Vehicle 100

The mobile shop vehicle 100 has equipment for opening a shop in its cabin, which will not be described in this specification. The following description will be mainly focused on its function as a vehicle that is common to the plurality of mobile shop vehicles 100.

The mobile shop vehicle 100 has a sensor 101, a positional information acquisition unit 102, a control unit 103, a driving unit 104, and a communication unit 105. The mobile shop vehicle 100 may be either an internal combustion engine vehicle or an electric vehicle. Thus, the mobile shop vehicle 100 operates by an internal combustion engine or power supplied from a battery.

The sensor 101 senses conditions of the vehicle or the environment of the vehicle. Examples of the sensor 101 for sensing conditions of the vehicle include an acceleration sensor, a speed sensor, and an azimuth sensor. Examples of the sensor 101 for sensing the environment of the vehicle include a stereo camera, a laser scanner, a LIDAR, and a radar. Information acquired by the sensor 101 is sent to the control unit 103.

The positional information acquisition unit 102 acquires the current position of the vehicle, which typically includes a GPS (Global Positioning System) device that receives GPS satellite signals to acquire positional information. Information acquired by the GPS device represents the latitude, longitude, and altitude. The positional information acquisition unit 102 may include any positioning device that can determine the current position of the vehicle. For example, the positional information acquisition unit may include a positioning device utilizing a global navigation satellite system (GNSS) other than the GPS or a positioning apparatus utilizing base stations.

The control unit 103 is a computer that controls the mobile shop vehicles 100 using information acquired by the sensor 101. The control unit 103 is constituted by, for example, a microcomputer.

The control unit 103 includes as functional modules an operation plan creation part 1031, an environment perceiving part 1032, a travel control part 1033, and an information sending part 1034. These functional modules may be implemented by executing programs stored in storage, such as a read only memory (ROM), by a central processing unit (CPU).

The operation plan creation part 1031 receives an operation command from the server apparatus 200 and creates an operation plan of the vehicle. In this embodiment, the operation plan includes data relating to a route along which the mobile shop vehicle 100 is to travel and data relating to formation of a shopping mall. Examples of data included in the operation plan are as follows.

### (1) Data Specifying a Route Along Which the Vehicle is to Travel

This data represents a travel route to an area in which the shopping mall is to be formed. The route along which the vehicle is to travel may be created, for example, automatically from a given place of departure and a given destination using map data stored in storage. Alternatively, the route may be created using an external service. This data may also include data specifying a route to a certain place to which the mobile shop vehicle should return after the end of the operation.

### (2) Data Relating to Formation of a Shopping Mall

This data relates to a shopping mall to be formed in a certain area. For example, this data include information about the order of disposition of a plurality of mobile shop vehicles 100 and information about a path along which the disposed mobile shop vehicle 100 is to move while operating as a shop. This path will be hereinafter referred to as the “movement path”. The data may also include information about the business hours.

The operation plan creation part 1031 creates, for example, such an operation plan that causes the mobile shop vehicle 100 to travel to a designated area, form a shopping mall in that area, and operate as a shop. The operation plan created by the operation plan creation part 1031 is sent to the travel control part 1033, which will be described later.

The environment perceiving part 1032 perceives the environment around the vehicle using the data acquired by the sensor 101. What is perceived includes, but is not limited to, the number and the position of lanes, the number and the position of other vehicles present around the vehicle, the number and the position of obstacles (e.g. pedestrians, bicycles, structures, and buildings) present around the vehicle, the structure of the road, and road signs. What is perceived may include anything that is useful for autonomous traveling.

The environment perceiving part 1032 may track a perceived object(s). For example, the environment perceiving part 1032 may calculate the relative speed of the object from the difference between the coordinates of the object determined in a previous step and the current coordinates of the object.

The data relating to the environment acquired by the environment perceiving part 1032 is sent to the travel control part 1033 described below. This data will be hereinafter referred to as “environment data”.

The travel control part 1033 controls the travel of the vehicle on the basis of the operation plan created by the operation plan creation part 1031, the environment data acquired by the environment perceiving part 1032, and the positional information of the vehicle acquired by the positional information acquisition unit 102. For example, the travel control part 1033 causes the vehicle to travel along a predetermined route in such a way that obstacles will not enter a specific safety zone around the vehicle. A known autonomous driving method may be employed to drive the vehicle. The travel control part 1033 serves as the movement controller, the second movement controller, and the vehicle distance controller according to the present disclosure.

While autonomous driving on roads has been described above, autonomous movement after the formation of a shopping mall is also controlled by the environment perceiving part 1032 and the travel control part 1033. The speed of movement on roads may be higher than the speed of movement during the operation in shopping malls.

The information sending part 1034 sends the positional information acquired by the positional information acquisition unit 102 and vehicle information to the server apparatus 200. The vehicle information is information about the vehicle, examples of which include, but are not limited to, identification data of the mobile shop vehicle 100 and information about the purpose and type of the mobile shop vehicle 100, the location at which the mobile shop vehicle 100 is on standby (e.g. a service office), the door type, the vehicle body size, the cabin size, the carrying capacity, the full charge driving range, the present (or remaining) driving range, and the present status (such as currently executing a certain task). The information sending part 1034 serves as the information sender according to the present disclosure.

The driving unit 104 controls the function of the mobile shop vehicle 100 as a vehicle. The driving unit 104 includes, for example, an engine or a motor and inverter, a brake, a steering system, and an electronic control unit (ECU) that controls these components.

The communication unit 105 connects the mobile shop vehicle 100 to a network. The communication unit 105 according to this embodiment is configured to be capable of communicating with other devices (e.g. the server apparatus 200) via a network using a mobile communication service based on e.g. 3G or LTE. The communication unit 105 may further be configured for inter-vehicle communication with other mobile shop vehicles 100.

### SERVER APPARATUS 200

Next, the server apparatus 200 will be described. The server apparatus 200 creates operation commands for the mobile shop vehicles 100. The server apparatus 200 includes a communication unit 201, a control unit 202, and a storage unit 203.

The communication unit 201 is a communication interface similar to the communication unit 105, for communication with the mobile shop vehicles 100 via a network.

The control unit 202 performs overall control of the server apparatus 200. The control unit 202 is constituted by, for example, a CPU.

The control unit 202 includes as functional modules a vehicle information management part 2021 and an operation command creation part 2022. These functional modules may be implemented by executing programs stored in storage, such as a ROM, by the CPU.

The vehicle information management part 2021 manages a plurality of mobile shop vehicles 100 that are under its management. Specifically, the vehicle information management part 2021 receives data about the mobile shop vehicle 100 from the plurality of mobile shop vehicles 100 at predetermined intervals and stores the data in the storage unit 203, which will be described later. In this embodiment, the vehicle information management part 2021 receives the positional information and the vehicle information as the data about the mobile shop vehicle 100.

When a request for operation of mobile shop vehicles 100 is received from outside, the operation command creation part 2022 determines the mobile shop vehicles 100 to be dispatched and creates an operation command according to the request for operation. The request for operation may be, for example, a request for forming a shopping mall at a certain place. This request may include information about a destination, attributes of mobile shop vehicles 100 to be dispatched, and the business hours. The request for operation is made by, for example, a manager of the system or the company that runs the system.

The mobile shop vehicles 100 to which the operation command is sent are determined, for example, on the basis of the positional information and the vehicle information (indicating whether the vehicle can be used to form a shopping mall) of the vehicles that the vehicle information management part 2021 has received.

The storage unit 203 stores information, which is constituted by a storage medium such as a RAM, a magnetic disc, or a semiconductor memory.

### Processing

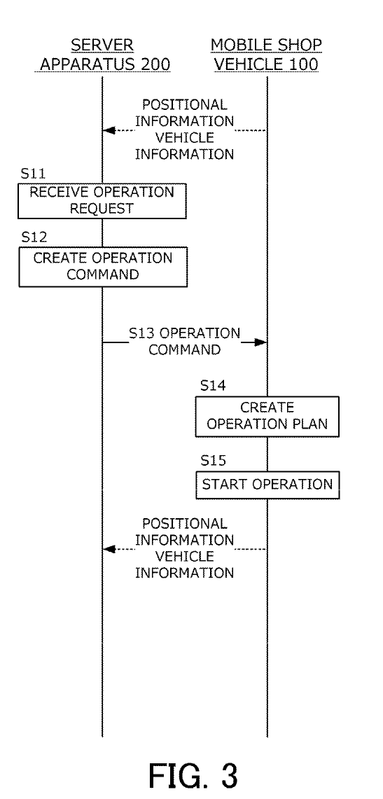

Processing performed by each of the above-described elements will now be described. FIG. 3 is a diagram illustrating dataflow during a process in which the server apparatus 200 creates an operation command based on a request for operation it has received and mobile shop vehicles 100 start to operate on the basis of the operation command. The process illustrated in FIG. 3 is merely an example. A shopping mall may be formed by a process different from that illustrated in FIG. 3.

Each mobile shop vehicle 100 periodically sends positional information to the server apparatus 200. In the case where the road network is defined by nodes and links, the positional information may be information that designates a node or link. Alternatively, the positional information may be longitude and latitude. The vehicle information management part 2021 stores the association of each mobile shop vehicle 100 with its positional information sent to the server apparatus 200 in the storage unit 203. The positional information is updated every time the mobile shop vehicle 100 moves.

Each mobile shop vehicle 100 periodically sends vehicle information to the server apparatus 200. In this embodiment, the vehicle information sent by the mobile shop vehicle 100 includes the following information. Among the following kinds of information, the information about characteristics intrinsic to the mobile shop vehicle 100 does not need to be sent repeatedly.
information about attributes of the vehicle (e.g. the type of the vehicle or shop)
information about the remaining battery capacity (SOC)
information about the driving range
information about the travel route (in cases where the vehicle is operating)

In cases where the mobile shop vehicle 100 is not operating (e.g. parked in a service office), the positional information and the vehicle information that were sent last time are regarded as the newest information.

In the process illustrated in FIG. 3, the server apparatus 200 (specifically, the operation command creation part 2022) receives a request for operation from a system manager (step S11).

The request for operation includes information about the area in which a shopping mall is to be formed, information about the time period through which the shopping mall is to be opened, and information about mobile shop vehicles 100 (e.g. identification data of the shops and/or information about the types of the shops).

Examples of the area in which a shopping mall is to be formed include, but are not limited to, a park, the site of a public facility, and the site of an apartment complex. In the following, a case where a shopping mall is formed in the site of an apartment complex will be described by way of example.

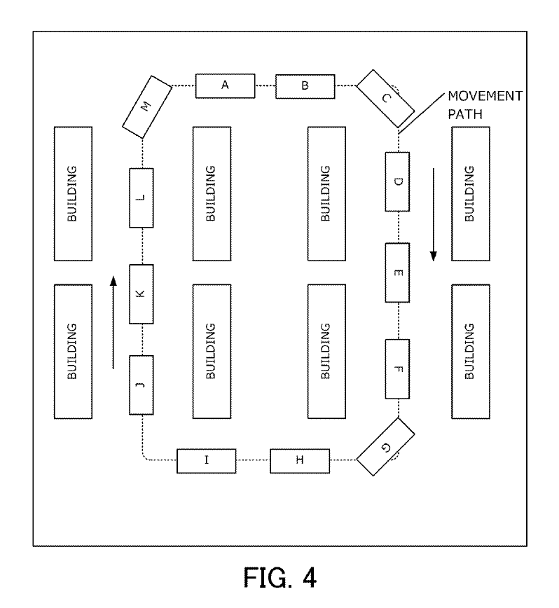

FIG. 4 illustrates the site of a housing complex in which a plurality of mobile shop vehicles 100 (in the case described here, thirteen vehicles in total, which are denoted by A to M). In the case described here, the plurality of mobile shop vehicles 100 operate as shops while moving along a movement path in a predetermined direction (e.g. clockwise) at low speed (e.g. lower than 1 km per hour).

In response to the request, the server apparatus 200 (specifically, the operation command creation part 2022) creates an operation command so as to cause mobile shop vehicles 100 to travel to a designated place to form a shopping mall (step S12). The operation command includes the following data.
identification data of the plurality of mobile shop vehicles 100 to which the operation command is sent
information specifying the area in which the shopping mall is to be formed
information specifying the time period through which the shopping mall is to be opened
information about a movement path in the area
lineup information

Information about the movement path in the area specifies a path like that shown in FIG. 4. The mobile shop vehicles 100 arriving at the area are arranged on the movement path. The information about the movement path may be either stored in the server apparatus 200 in advance or received at the time when the request for operation is received.

The lineup information is information that specifies how the mobile shop vehicles 100 are arranged in the movement path. For example, the lineup information may specify a lineup of the thirteen mobile shop vehicles 100 designated by A to M arranged in the alphabetical order clockwise.

The mobile shop vehicles 100 to which the operation command is sent are determined on the basis of the request for operation and the positional information and the vehicle information of the mobile shop vehicles 100 stored in the server apparatus 200. For example, the operation command creation part 2022 refers to the above information and selects mobile shop vehicles 100 that can provide the requested service.

The operation command created by the operation command creation part 2022 is sent to the selected mobile shop vehicles 100 through the communication unit 201 (step S13).

In step S14, each mobile shop vehicle 100 (specifically, the operation plan creation part 1031) creates an operation plan based on the operation command it has received. For example, each mobile shop vehicle 100 creates the operation plan with designation of a route of travel and a destination that the mobile shop vehicle 100 is to execute the task of forming a shopping mall at the destination (which will be described specifically later) and to return to a predetermined place after the end of the operation.

The operation plan created as above is sent to the travel control part 1033, and then the operation is started (step S15). The positional information and the vehicle information are sent to the server apparatus 200 periodically during the operation also.

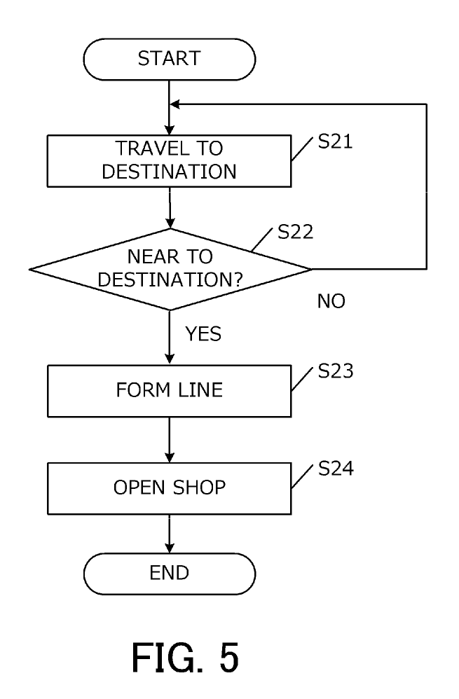

FIG. 5 is a flow chart of the process performed by each mobile shop vehicle 100 after the start of operation in step S15.

Firstly in step S21, the travel control part 1033 causes the mobile shop vehicle 100 to start to travel to the destination on the basis of the operation plan created as above. The destination is the area designated by the request for operation.

When the mobile shop vehicle 100 comes near to the destination (step S22), the travel control part 1033 searches for a place in the neighborhood where the mobile shop vehicle 100 can stop, stops the vehicle there, and forms a line with the other mobile shop vehicles 100 present around using communication with the other vehicles (step S23). Specifically, for example, a determination is made as to whether all the vehicles that are to form the shopping mall have gathered using inter-vehicle communication, and if all the vehicle have already gathered, they line up on the designated movement path in the designated order. Thus, the shops are prepared. The process of step S23 may be carried out in other ways, so long as the mobile shop vehicles 100 can line up on the designated movement path in the designated order. For example, each mobile shop vehicle 100 may be set at a designated position on the movement path before all of the vehicles gather.

After the completion of the lining-up of all the mobile shop vehicles 100 that are to form the shopping mall, the mobile shop vehicles 100 notify the crews of each vehicle the fact that the shop may be opened to request them to open the shop (step S24). In this step, alternatively, opening of the shops may be announced simultaneously to the crews of all the vehicles after the crews of all the vehicles have done necessary preparation. When the shopping mall is opened, all the mobile shop vehicles 100 start to move at low speed along the designated movement path. Control of autonomous movement along the movement path may be performed either all or some of the mobile shop vehicles 100 that form the shopping mall. In the case where the control is performed by only some of the mobile shop vehicles 100, the other mobile shop vehicles 100 may perform only control for following the mobile shop vehicle 100 immediately ahead.

The mobile shop vehicle 100 operating as a shop does not need to move always at a constant speed. For example, the mobile shop vehicle 100 may decelerate or stop temporarily when customers get on or off the vehicle (e.g. when the entrance door is open). In that case, the distance between that vehicle and the vehicle immediately ahead of or behind it may be adjusted automatically. For example, the speed of the mobile shop vehicle 100 may be adjusted so that the distance to the vehicle immediately ahead of it will not become shorter (or longer) than a predetermined distance. It is desirable that an upper limit (e.g. 1 km per hour) be placed on the speed of movement for safety.

After the end of the predetermined business hours, each mobile shop vehicle 100 stops movement and performs a post-process according to the operation plan. For example, the mobile shop vehicle 100 may perform the process of closing the shop or the control for autonomously returning to a predetermined place.

As above, according to the first embodiment, there is provided a system that can automatically construct a shopping mall by mobile shop vehicles 100. Since the mobile shop vehicles 100 circulate at low speed along a predetermined path as shown in FIG. 4, customers (e.g. residents of the apartment complex) can enjoy the advantageous effect that different shops come in front of their own house in different time periods. This allows the customers to visit a plurality of shops with little effort.

### Second Embodiment

In the system according to the second embodiment, the mobile shop vehicles 100 that make up a shopping mall send positional information to the server apparatus 200, and the server apparatus 200 creates map information (shop map) indicating the shop layout on the basis of the positional information.

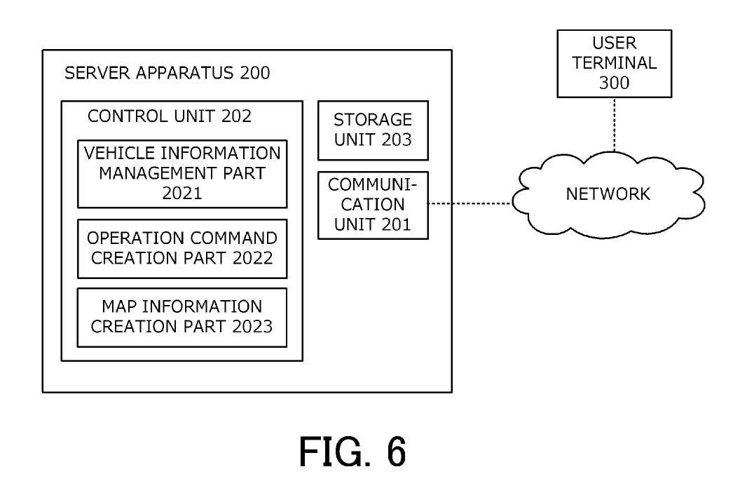

FIG. 6 is a diagram illustrating the configuration of a mobile shop system according to the second embodiment. The mobile shop vehicles 100 included in this system are not illustrated in FIG. 6. As illustrated in FIG. 6, the mobile shop system according to the second embodiment is basically the same as that according to the first embodiment, but further includes user terminals 300 that can be connected to a network. Moreover, the control unit 202 of the server apparatus 200 further includes a map information creation part 2023.

In the system according to the second embodiment, the information sending part 1034 of the mobile shop vehicle 100 sends information about its own shop to the server apparatus 200. The information about its own shop may include identification data of the mobile shop vehicle 100, identification data of the shop associated with the mobile shop vehicle 100, information about the category of the shop, announcement (e.g. advertisement), positional information in the area in which the shopping mall is formed, information about the direction of movement, the speed, the acceleration, and the movement path of the mobile shop vehicle 100. Such information will be collectively referred to as “shop information” hereinafter.

The map information creation part 2023 temporarily stores shop information sent from the mobile shop vehicles 100 and creates a shop map on the basis of the stored shop information. More specifically, the map information creation part 2023 creates information (e.g. figurative or text information) indicating what shops are located at which positions on the movement path. In response to a request made from a user terminal 300, the shop map created as above is sent to that user terminal 300 through the network.

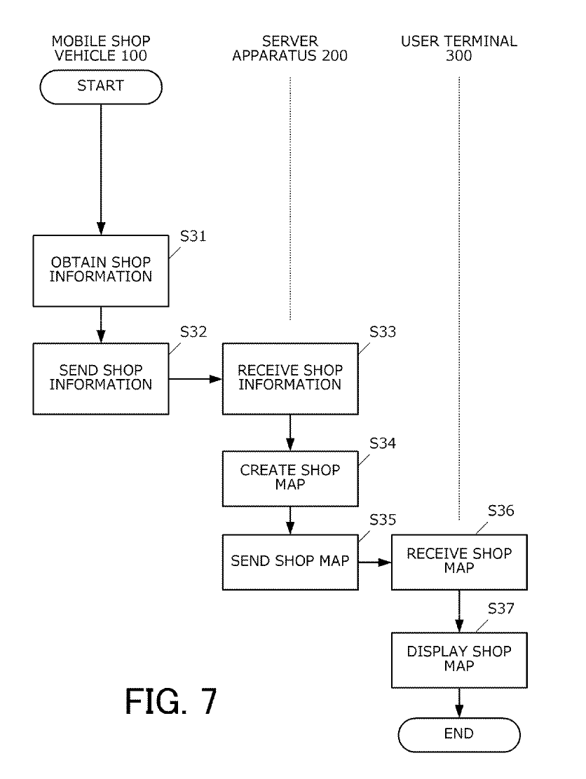

FIG. 7 is a diagram illustrating processes performed by elements of the system according to the second embodiment.

Firstly in step S31, the mobile shop vehicle 100 (specifically, the information sending part 1034) obtains shop information. The shop information may be obtained by reading previously stored information or created from a result of sensing.

Then in step S32, the information sending part 1034 sends the obtained shop information to the server apparatus 200. The server apparatus 200 stores the shop information sent to it in the storage unit 203 temporarily (step S33).

Then in step S34, the map information creation part 2023 creates a shop map that indicates the positions of the mobile shop vehicles 100 on the basis of the shop information received from the mobile shop vehicles 100. Information about not only the positions but also the orientations of the mobile shop vehicles 100 may be used to create a shop map indicating the orientations of the mobile shop vehicles 100.

The shop map may be created in such a way as to make the names of the types of the shops recognizable. For example, the respective shop names may be displayed in such a way as to be superposed on the indications of the mobile shop vehicles 100 in the map. The mobile shop vehicles 100 may be displayed in the map in appearances (e.g. colors) varied according to the types of the shops.

In step S35, the map information creation part 2023 sends the shop map created as above to the user terminal 300 through the communication unit 201. The processing of this step may be executed, for example, in response to a request made from the user terminal 300.

In step S36, the user terminal 300 receives the shop map, and then the user terminal 300 displays the shop map on its display in step S37.

The system according to the second embodiment can inform customers of where the mobile shop vehicles 100 in the shopping mall are located presently.

The map information creation part 2023 may only create the shop map or send a notice to a user terminal 300, according to a request from the user terminal 300, when a designated shop comes to a designated location.

The positional information of each mobile shop vehicle 100 can be acquired using a GPS module or the like. Additional devices may also be used to improve the accuracy of the positional information. For example, the mobile shop vehicle 100 may acquire relative positional relationship with a perceivable object(s) present around it using a sensor or a camera and send information thus acquired to the server apparatus 200. The server apparatus 200 may calculate the current position of the mobile shop vehicle 100 using this information. Thus, the positional information can be created with improved accuracy. Information representing the relative positional relationship between the mobile shop vehicle 100 and an object present around it is an example of positional information representing the position of the mobile shop vehicle 100. No limitation is placed on the kind of information to be obtained, so long as the position of the mobile shop vehicle 100 on the movement path can be calculated from that information.

The processing of calculating the relative positional relationship between the mobile shop vehicle 100 and an object present around it using information obtained through the camera or sensor may be executed by either the mobile shop vehicle 100 or the server apparatus 200. Alternatively, the calculation may be executed by other apparatuses.

### Third Embodiment

In the system according to the second embodiment, the server apparatus 200 creates a shop map at the present time using positional information of the mobile shop vehicles 100. In the third embodiment, a shop map at a future time is created on the basis of prediction about the positions of the mobile shop vehicles 100 at the future time.

In the third embodiment, the map information creation part 2023 predicts the positions of the mobile shop vehicles 100 in the future on the basis of stored information. For example, the map information creation part 2023 predicts the positions of the mobile shop vehicles 100 at future times on the basis of the shop information it has received from the mobile shop vehicles 100 and the operation command it has sent to the mobile shop vehicles 100. Thus, a shop map at a desired time can be created.

In the system according to the third embodiment, the map information creation part 2023 sends a shop map for a time designated by a user terminal 300 to it.

Since the system according to the third embodiment can create not only a shop map at the present time but also shop maps at future times. This improves the convenience of customers.

In the system according to the third embodiment, prediction is performed by the server apparatus 200 on the basis of shop information (at the present time) received from the mobile shop vehicles 100. Alternatively, the mobile shop vehicles 100 may provide predictive information. For example, the mobile shop vehicles 100 may predict their positions at future times and include the information obtained by the prediction in the shop information sent to the server apparatus 200. Thus, the server apparatus 200 can know the positions of the mobile shop vehicles 100 at future times. The positions at future times can be calculated, for example, on the basis of the operation plan created by each mobile shop vehicle 100.

### Fourth Embodiment

In the system according to the third embodiment, a created shop map is sent to user terminals 300. In the fourth embodiment, the server apparatus 200 sends a shop map to mobile shop vehicles 100. In the system according to the fourth embodiment, the mobile shop vehicle 100 is configured to be capable of displaying a shop map on its display and sending the shop map to user terminals 300.

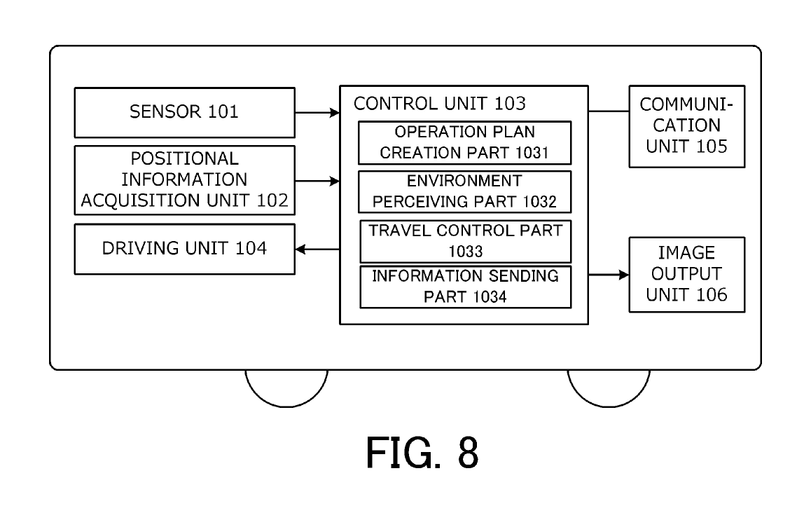

FIG. 8 is a diagram illustrating the configuration of a mobile shop system according to the fourth embodiment. In FIG. 8, the server apparatus 200 and the user terminal 300 included in the system are not illustrated. In the system according to the fourth embodiment, the mobile shop vehicle 100 includes an image output unit 106.

The mobile shop vehicle 100 in the system according to the fourth embodiment has a display provided on the outer side of its body, to which images can be output. The image output unit outputs images to the outside display on the vehicle body. The outside display may be a liquid crystal display, an organic EL display, or a display composed of an LED matrix.

In the system according to the fourth embodiment, a shop map created by the map information creation part 2023 is sent to the mobile shop vehicles 100 via a network. The shop map thus sent is displayed by the image output unit 106. Moreover, the mobile shop vehicle 100 according to the fourth embodiment is configured to be capable of sending the shop map to a user terminal 300 in response to a request from that user terminal 300. Thus, customers can get information about the shop layout quickly.

### Fifth Embodiment

In the systems according to the first to fourth embodiments, the mobile shop vehicles 100 have been described to move on the movement path at constant speed. However, the speed of movement on the movement path is not necessarily required to be constant. For example, the movement path may be divided into a plurality of areas, and the speed of movement of the mobile shop vehicles 100 may be varied from area to area. For example, an area in which sales are intended to be promoted (which will be referred to as “sales area”) and the other area (which will be referred to as “restricted area”) may be provided. The speed of movement may be controlled in such a way as to be made higher in the restricted area and returned to a normal movement speed in the sales area. The restricted area may be set in an area to which fewer customers come or in an area in which it is not appropriate for customers to get on or off the mobile shop vehicles 100 (e.g. an area including a road).

This control enables the mobile shop vehicles 100 to skip the area in which sales are not intended to be promoted while moving. In the restricted area, getting on or off the mobile shop vehicles 100 may be temporarily restricted, or the shops may be closed temporarily.

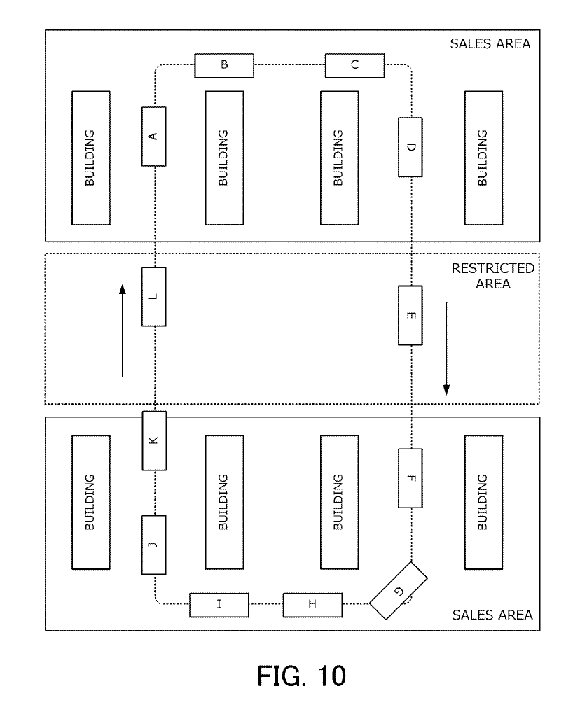

A plurality of sales areas and a plurality of restricted areas may be set in a movement path. For example, as illustrated in FIG. 10, a plurality of different areas may be set as sales areas, and the areas between them may be set as restricted areas.

### Other Embodiments

The above embodiments have been described merely as illustrative examples. Features of two or more embodiments may be adopted in combination, or modifications may be made to the embodiments without departing from the essence of the present disclosure. A process described to be performed by one apparatus may be performed by a plurality of apparatuses by distributed processing. A process described to be performed by different apparatuses may be performed by a single apparatus. The hardware configuration (or server configuration) employed to implement the functions of a computer system may be modified flexibly.

In the above description of the embodiments, the mobile shop vehicles 100 have been described to keep the same order in the line while moving. However, the disposition of the mobile shop vehicles 100 may be varied appropriately. Moreover, one or some of the mobile shop vehicles 100 may be removed or an additional mobile shop vehicle(s) 100 may be added during the operation. In other words, rearrangement and/or replacement of mobile shop vehicles 100 may be performed. The server apparatus 200 may be configured to send a command for such rearrangement or displacement to mobile shop vehicles 100. Rearrangement or replacement of mobile shop vehicles 100 may be carried out in either a sales area or a restricted area.

What is claimed is:

1. A mobile shop vehicle capable of opening a shop at a destination, comprising:
a movement controller configured to cause the mobile shop vehicle to move autonomously along a predetermined path in a predetermined area while opening a shop; and
a vehicle distance controller configured to control the distance to another mobile shop vehicle that is autonomously moving.

2. A mobile shop vehicle according to claim 1, further comprising
a second movement controller configured to cause the mobile shop vehicle to move autonomously outside the predetermined area, the second movement controller being configured to cause the mobile shop vehicle to move autonomously at a speed higher than the speed of movement in the predetermined area.

3. A mobile shop vehicle according to claim 1, wherein
the movement controller causes the mobile shop vehicle to move autonomously at a first speed and causes the mobile shop vehicle to move autonomously at a second speed lower than the first speed during a period in which a visitor is getting on or off the mobile shop vehicle.

4. A mobile shop system including a plurality of mobile shop vehicles capable of moving autonomously on the basis of an operation command and opening a shop at a destination and a server apparatus that creates the operation command, wherein
each of the mobile shop vehicles comprises a movement controller configured to cause the mobile shop vehicle to move autonomously in a predetermined area while opening a shop on the basis of the operation command, and
the server apparatus comprises a commander configured to create the operation command so as to cause the plurality of mobile shop vehicles to move along the same path while keeping predetermined intervals between them.

5. A mobile shop system according to claim 4, wherein
each of the mobile shop vehicles further comprises a positional information sender that acquires and sends positional information, and
the server apparatus further comprises a positional information receiver configured to receive the positional information of the plurality of mobile shop vehicles and
a map creator configured to create map information representing the disposition of the plurality of mobile shop vehicles.

6. A mobile shop system according to claim 5, wherein
the map creator predicts the disposition of the mobile shop vehicles at a future time and creates the map information for that time.

7. A mobile shop system according to claim 4, wherein
each of the mobile shop vehicles further comprises a second movement controller configured to cause the mobile shop vehicle to move autonomously outside the predetermined area, the second movement controller being configured to cause the mobile shop vehicle to move autonomously at a speed higher than the speed of movement in the predetermined area.

8. A mobile shop system according to claim 4, wherein
the movement controller causes the mobile shop vehicle to move autonomously at a first speed and causes the mobile shop vehicle to move autonomously at a second speed lower than the first speed during a period in which a visitor is getting on or off the mobile shop vehicle.

9. A mobile shop system according to claim 4, wherein
the commander creates an operation command that causes one or some of the plurality of mobile shop vehicles to leave the path or an operation command that causes an additional mobile shop vehicle to enter the path.
